(19) United States
(12) Patent Application Publication
(10) Pub. No.: US 2022/0003288 A1
(43) Pub. Date: Jan. 6, 2022

(54) METHOD FOR DETERMINING DESIGN PARAMETERS OF AN ELECTROMECHANICAL BRAKE, AND ELECTROMECHANICAL BRAKE

(71) Applicant: GREENBRAKES GMBH, Hartberg (AT)

(72) Inventor: Michael PUTZ, Sebersdorf (AT)

(73) Assignee: GREENBRAKES GMBH, Hartberg (AT)

(21) Appl. No.: 17/277,821

(22) PCT Filed: Sep. 17, 2019
(86) PCT No.: PCT/EP2019/074897

§ 371 Date: Mar. 19, 2021

(30) Foreign Application Priority Data
Sep. 19, 2018 (AT) A 50800/2018

(51) Int. Cl. F16D 65/18; F16D 55/226

(52) U.S. Cl. CPC F16D 65/18; F16D 2121/24; F16D 55/226

(57) ABSTRACT

A method for determining design parameters of an electromechanical brake is provided. The brake comprises an electric motor connected to a brake lining by a transmission. The brake lining can be pressed against a friction lining movable relative to the brake lining. The electric motor is connected to the brake lining by a transmission that has a transmission ratio which is not constant over an actuation stroke. A reliable and economical brake is achieved in that an electric motor, a brake lining and a friction lining are selected, whereupon the transmission ratio is selected on the basis of the counter-torque acting over the actuation stroke, which counter-torque acts on the transmission. The transmission ratio is selected in such a way that the electric motor is operated at an optimal operating point, in particular at an operating point of maximum power, substantially over the entire actuation stroke.

### CROSS-REFERENCE TO RELATED APPLICATIONS

The present application is a national phase application of PCT Application No. PCT/EP2019/074897, filed Sep. 17, 2019, entitled “METHOD FOR DETERMINING DESIGN PARAMETERS OF AN ELECTROMECHANICAL BRAKE, AND ELECTROMECHANICAL BRAKE”, which claims the benefit of Austrian Patent Application No. 50800/2018, filed Sep. 19, 2018, each of which is incorporated by reference in its entirety.

### BACKGROUND OF THE INVENTION

### 1. Field of the Invention

The invention relates to electromechanical brakes, and in particular methods for designing electromechanical brakes.

### 2. Description of the Related Art

Various brakes of the type referenced above, which are usually used for motor vehicles, are known from prior art. The aim of such brakes is always to ensure a safe and reliable actuation of the brake by means of the electric motor and, at the same time, to provide a cost-effective design. For this purpose, the use of a transmission with a transmission ratio which is not constant over an actuation stroke was proposed in the document AT 513 989 A1, wherein the transmission ratio is high at the beginning of a stroke so that an air gap between the brake lining and the friction lining can be overcome quickly, whereupon the transmission ratio decreases in order to achieve a required high contact force. It has been found to be disadvantageous in brakes of this type that, during real operation of the corresponding brake, the electric motor is sometimes not operated in a desired maximum power range, but often locks up.

### SUMMARY OF THE INVENTION

The invention relates to a method for determining design parameters of an electromechanical brake, the brake comprising an electric motor which is connected to a brake lining by means of a transmission, which brake lining can be pressed against a friction lining movable relative to the brake lining, the electric motor being connected to the brake lining by means of a transmission that has a transmission ratio which is not constant over an actuation stroke.

The invention also relates to an electromechanical brake, the brake comprising an electric motor and a brake lining and a friction lining arranged to be movable relative to the brake lining, wherein the brake lining can be pressed against the friction lining by means of the electric motor in order to convert mechanical energy into thermal energy by means of the friction between the brake lining and the friction lining.

The object of the invention is to provide a method of the type described above, with which the design parameters of an electromechanical brake, which is intended to be used for a motor vehicle or the like, can, for example, be determined in such a way that a more reliable actuation and minimum installation space are ensured at the same time.

In addition, the invention seeks to specify an electromechanical brake of the type mentioned at the outset that ensures a more reliable actuation and minimum installation space at the same time.

The first object is achieved by a method of the type described at the beginning in which an electric motor, a brake lining and a friction lining are selected, whereupon the transmission ratio is selected on the basis of the counter-torque acting over the actuation stroke, which counter-torque acts on the transmission on account of the selected electric motor, the selected brake lining and the selected friction lining and a mechanical connection of these elements. The transmission is selected in such a way that the electric motor is operated at an optimal operating point, in particular an operating point of maximum power, substantially over the entire actuation stroke.

In the context of the invention, it was recognized that when selecting the transmission ratio that changes over the actuation stroke, the brake lining, the friction lining and the mechanical connection between the brake lining and the friction lining must be taken into account since these elements influence a counter-torque which acts on the electric motor on account of the actuation stroke and that depends on the actuation stroke. Thus, while the brake lining passes through an air gap which separates the brake lining from the friction lining when the brake is open, a low counter-torque is present and, when the brake lining comes into contact with the friction lining, a higher counter-torque, which in turn depends on the elasticity or stiffness of the brake lining and friction lining, is present.

A transmission ratio is understood here to refer to a ratio between a movement of the brake lining relative to the friction lining and a movement of the electric motor or, in the case of a rotating motor, to a revolution speed of the electric motor. The transmission ratio is thus defined as the transmission ratio or movement transmission ratio between a movement of the output of the transmission and a movement at an input of the transmission at which the electric motor is connected to the transmission. At a constant revolution speed or constant speed of the electric motor, a faster movement of the brake lining is therefore achieved with a high transmission ratio than with a low transmission ratio.

Usually, a course of this counter-torque is calculated over the actuation stroke, whereupon the transmission ratio of the transmission is adapted to the counter-torque over the actuation stroke in such a way that the electric motor is operated at an optimal operating point, in particular at an operating point of maximum power, over the entire actuation stroke. The optimal operating point is understood here to be the operating point which, on the one hand, ensures a reliable actuation of the brake and, on the other hand, a minimal actuation time. This operating point can vary depending on a motor characteristic curve over the actuation stroke, for example, in order to bring the electric motor into a range of maximum power as quickly as possible.

It is advantageous if a counter-torque, which acts on the electric motor during an actuation during an actuation stroke, is determined mathematically, in particular on the basis of tolerances, an air gap between the brake lining and the friction lining when the brake is open, friction losses in the transmission and/or possible thermal expansions, and is taken into account when determining the variable ratio. In particular, for a range of the actuation stroke in which the air gap is overcome, a very high, advantageous transmission ratio can result mathematically if a friction in the transmission is not taken into account. In particular, if the transmission has a cam disk, a ball ramp or the like in order to design the transmission dependent on the actuation stroke, self-locking can occur in practice in this case due to the existing friction. It is therefore advantageous, when designing the transmission or the transmission ratio, to take into account any friction that occurs up to a maximum possible friction coefficient in order to ensure a reliable actuation of the brake.

The brake is preferably designed in such a way that a reliable actuation is still possible even in the most unfavorable case, i.e., when, for example, tolerances of the mechanical, magnetic and electrical elements are used in the most unfavorable manner so that a maximal counter-torque is still possible. To this effect, various combinations of used tolerances can be simulated arithmetically and thus the most unfavorable combination deduced. The brake or the transmission ratio is then designed for the counter-torque that occurs over the actuation stroke in this most unfavorable combination.

The brake is generally designed in such a way that a safe actuation, i.e., a motor torque that exceeds the counter-torque acting on the electric motor, is ensured even if all parameters of all elements of the brake use possible tolerances in the most unfavorable manner so that a counter-torque is at a maximum. As a rule, maximum unfavorable thermal expansions are also taken into account. This avoids the case that the electric motor locks up, which occurs frequently with the corresponding brakes from prior art, because, for example, at a high transmission ratio, which would theoretically be beneficial for quickly overcoming the air gap, the air gap has already been overcome due to expansions and/or tolerances, making the counter-torque transferred to the electric motor by the transmission greater than a motor torque available in the electric motor.

The counter-torque is usually determined with a numerical simulation in order to allow for a particularly precise design of the brake so that the electric motor is substantially at an optimal operating point over the entire operating stroke, i.e., between an open position of the brake and a closed position of the brake, and can, in particular, be operated at an operating point at which an output of the electric motor is at a maximum. A closing process of the brake can also be simulated in its entirety in order to determine the counter-torque, which may be defined by dynamic effects, and to adapt the ratio to the worst possible case so that a torque available in the electric motor is always above the counter-torque.

It has been proven advantageous that, when determining the transmission ratio which is not constant over an actuation stroke, a reduction in the motor torque, which is caused by a demagnetization at the end of a planned service life, increased temperature, manufacturing tolerances and/or a reduction in the supply voltage down to a lower limit at which a function of the brake still has to be guaranteed, is taken into account.

The brake is thus designed in such a way that the motor torque available in the electric motor is always greater than a counter-torque that is required to move the brake lining or to press the brake lining against the friction lining, even taking into account the most unfavorable circumstances such as demagnetization, increased temperature, manufacturing tolerances and/or a reduction in the supply voltage, in order to achieve a reliable actuation even under unfavorable operating conditions and after the occurrence of mechanical, electrical and magnetic aging effects.

By selecting appropriate parameters for the transmission ratio, which depends on the actuation stroke, the electric motor can be operated at an optimal operating point, in particular an operating point of maximum power, when actuated over the actuation stroke.

It is beneficial if the electric motor is operated in a maximum power range almost during the entire actuation stroke so that a reliable and at the same time rapid actuation of the brake can likewise be achieved with an electric motor which has a lower nominal power than electric motors of the corresponding prior art brakes since these electric motors can only be used to a small extent, usually due to the unfavorable transmission ratios of the transmission at least over a segment of the operating stroke. A reliable actuation of the brake according to the prior art is therefore only possible by significantly oversizing the electric motor. A brake designed with a method according to the invention thus has the same reliability and actuation time as the correspondingly oversized brakes of the prior art, but can be made much smaller and cheaper and with a less powerful electric motor due to a better utilization of the electric motor.

In a method for producing an electromechanical brake, it is, in order to achieve a small installation space with a simultaneously reliable actuation, advantageous if the electromechanical brake is produced according to design parameters which were determined in a method according to the invention. Such brakes can be used advantageously in particular in motor vehicles.

The further object according to the invention is achieved by an electromechanical brake of the type described at the outset, in which the electric motor is connected to the brake lining by means of a transmission that has a transmission ratio which is not constant over an actuation stroke. As a result, an optimal utilization of the electric motor can be guaranteed over the entire actuation stroke, so that a design that is more compact and cheaper than the prior art brakes is achieved due to a smaller electric motor.

The brake according to the invention is usually produced in a method according to the invention.

A brake according to the invention can be used for a motor vehicle such as a car or a truck. Alternatively, a brake according to the invention can of course also be used for other areas of application in which an element is braked relative to another element, in particular for elevators, robots and the like.

It is advantageous if the transmission ratio of the transmission is selected on the basis of the actuation stroke such that the electric motor, when actuated, can be operated over the entire actuation stroke at an optimal operating point, in particular an operating point of maximum power. As a rule, the transmission ratio is configured in such a way that the electric motor changes as quickly as possible from the open position of the brake to an operating point of maximum power when a voltage is applied, whereupon the electric motor remains in this operating point over the entire actuation stroke. It is advantageous if the transmission ratio, which is dependent on the actuation stroke, is selected over the actuation stroke in such a way that a reliable actuation of the electric motor is guaranteed even when tolerances, in particular manufacturing tolerances, are used in the most unfavorable manner by elements of the brake and/or in the most unfavorable environmental conditions such as, for example, an extreme temperature so that a counter-torque is at a maximum over the actuation stroke. In order to achieve a particularly cost-effective design, it is usually provided that a supply voltage of the electric motor is approximately constant during the actuation stroke. A brushless direct current motor is preferably used as the electric motor.

In order to implement the variable transmission ratio over the actuation stroke in a simple and robust manner, it is advantageous if the transmission has at least one ball ramp, preferably several ball ramps arranged evenly around an axis of rotation, with which the non-constant ratio over the actuation stroke is implemented. Corresponding ball ramps can, for example, be arranged along a circumferential direction about an axis of rotation of the electric motor and have different depths in the axial direction so that balls arranged in the ball ramps provide a different transmission ratio when the disk rotates depending on a gradient of the ball ramp at the respective position.

It is particularly preferred in this context if the transmission comprises two disks, which are connected by means of at least one ball arranged in a ball ramp, rotatable about an axis of rotation, wherein the transmission ratio of the transmission, which is not constant over the actuation stroke, is at least partially formed with the ball ramp. The disks can be preloaded via a spring or the like so that they are pressed against one another, and an axial distance between the disks depends on a position of the ball in the ball ramp. A disk can then be rotatably driven about the axis of rotation by the electric motor such that an axial distance between the two disks is defined by the design of the ball ramp. If the brake lining is connected to the second disk, the two disks and the ball mounted in the ball ramp thus form a transmission in which a transmission ratio that can be changed over the actuation stroke can be implemented in a simple and robust manner through different gradients of the ball ramp.

Alternatively or in addition, it can be provided that the transmission comprises at least one non-circular cam which is rotatably arranged about an axis of rotation and by means of which the electric motor is connected to the brake lining, wherein the transmission ratio of the transmission, which is not constant over the actuation stroke, is at least partially formed with the non-circular cam.

It has been proven advantageous that the transmission comprises a control disk attached to a shaft, the center of which is outside the shaft axis, or a lever in order to implement the transmission ratio which is not constant over the actuation stroke. This can be advantageous, in particular, for the use of a brake according to the invention in trucks.

The control disk or the lever can be driven directly or indirectly by the electric motor, in particular via a cam disk, a connecting rod or the like.

A ball ramp possibly contained in the transmission or a cam possibly contained in the transmission can also be driven by the electronic motor, either directly or indirectly. In addition, different types of transmissions can be combined in order to achieve the desired transmission ratio, which depends on the actuation stroke.

Furthermore, as an alternative or in addition to the structural implementation of the transmission, it can be provided that the transmission has a cam mechanism, a cam disk, a connecting rod and/or a coupling mechanism in order to implement the transmission ratio which is not constant over the actuation stroke.

It is advantageous if a wear adjuster is provided with which a position of the brake lining relative to the friction lining can be automatically adapted to the wear on the brake lining and the friction lining.

In order to achieve an electromechanical brake that is as inexpensive as possible, it is advantageous if a mechanical wear adjuster is used. A screw with a particularly large pitch can be arranged in a nut for this purpose, for example, herein the screw in the nut has as much play as is desired for the air gap of the brake. As long as the brake is actuated in the air gap, the nut does not move when the screw moves in the nut. However, if there is a larger air gap due to wear, the screw is rotated by the nut due to the large pitch because the screw comes into contact with the nut since the play has been used up. The screw is tightened in the same amount as the air gap is too large. If a higher contact pressure occurs, however, the screw cannot continue to rotate, which is why a simple locking device can be provided for the screw rotation by compressing a spring in the case of small contact pressure forces in order to bring about a frictional connection between the screw and the stationary part, which prevents any further screw rotation. Such mechanical wear adjusters are known for hand brakes in passenger cars but have not yet been used in electromechanical brakes.

A transmission ratio of the brake is usually selected such that a change in the elasticity of the brake is also taken into account. Such elasticity may be reduced or change, for example, as a result of the friction lining being worn.

It has been proven advantageous to design the transmission in such a way that the transmission ratio has both positive and negative values over the actuation stroke. Using a corresponding design, a brake can be formed which, for example, remains closed in a currentless state. From the point at which the transmission ratio changes its algebraic sign, a counter-torque acting on the motor side of the transmission due to the elasticity of the brake lining and the friction lining in the closed state of the brake does not cause any torque that could cause the electric motor to open the brake even in the currentless state. The brake can thus have a stable closed state in a currentless state. In terms of design, a corresponding change in the sign of the transmission ratio can be implemented, for example, by a ball ramp, which has a decreasing depth up to a predefined point of an actuation stroke, whereupon the depth of the ball ramp increases again so that a slope of the ball ramp also changes its algebraic sign.

It can further be provided that the transmission is designed such that the transmission ratio is zero at least over a partial segment of the actuation stroke so that, in this partial segment, a movement of the electric motor does not cause any movement of the brake lining relative to the friction lining. This can also ensure that the brake does not open automatically in a currentless state. As a result, a corresponding brake can easily be used as a parking brake in a motor vehicle so that the brake cannot be released when the battery is empty. In terms of design, a corresponding transmission ratio can be implemented, for example, by means of a ball ramp which has no gradient at least over a particular segment.

In order to be able to operate the brake in parallel to the electric motor in other ways, for example if the electric motor fails, it is advantageous if a cable connection is provided so that the brake lining can be pressed against the friction lining by pulling on a cable attached to the cable connection. A corresponding brake can then, for example, be actuated in a motor vehicle via the electric motor and a handbrake lever so that the brake is operated as a driving brake with the electric motor to form a brake-by-wire system while the brake can also be manually operated as a parking brake.

The brake can also be designed in such a way that it can be brought into a self-holding state when actuated by means of the cable connection while, by actuating the electric motor, the brake can be brought into a state in which the brake is released when no voltage is supplied.

A structurally particularly simple solution is found when the cable connection protrudes through a housing of the transmission and is movably connected to the housing by means of a seal so that the cable can be connected to the cable connection outside the housing and a movement of the cable is transmitted to the transmission by means of the cable connection. There is usually oil in the transmission, which is why an interior of the transmission is usually sealed off from the environment. Due to the appropriate design of the cable connection, which is preferably rotatably connected to the housing of the transmission, it is not necessary to guide the cable itself into the sealed transmission, making the resulting design particularly simple.

It is preferably provided that at least one further motor is provided with which the brake can be actuated independently of the electric motor. The further motor can also be designed as an electric motor. This ensures that the brake works even if an electric motor fails. Furthermore, a first electric motor can then be used to operate the brake as a driving brake and a second electric motor to operate the brake as a parking brake so that both functions can be realized independently of one another.

It is advantageous if a spring is provided which has a supporting effect when the brake is released so that a torque to be generated by the electric motor is reduced, wherein the spring acts, in particular, in such a way that the brake is at least partially open when the electric motor is currentless. As a result, a more reliable release of the brake and/or a reduced load on the electric motor can be achieved, for example, in order to achieve a brake that is self-releasing in a currentless state.

Alternatively or in addition, it can be provided that a spring is provided which has a supporting effect when the brake is actuated so that a torque to be generated by the electric motor is reduced, wherein the spring acts, in particular, in such a way that the brake is at least partially closed when the electric motor is currentless. As a result, a more reliable actuation of the brake and/or reduced stress on the electric motor can be achieved, for example, in order to achieve a brake that locks in the currentless state.

In the case of a vehicle with an electromechanical brake, it is advantageous if the electromechanical brake is designed according to the invention.

It can be provided that the electromechanical brake is designed as a driving brake in order to bring the moving vehicle to a standstill.

It can further be provided that the electromechanical brake is designed as a parking brake in order to prevent a parked vehicle from rolling away.

In addition to a possible actuation via the electric motor, it can be provided that the brake can also be actuated via a handbrake lever.

It is preferably provided that the handbrake lever is connected to the brake via a cable and a cable connection connected to the brake in such a way that the brake lining can be pressed against the friction lining by actuating the handbrake lever.

It has been proven advantageous if the cable connection has a lever which is connected to the transmission on the output side in such a way that an output of the transmission can be moved by a tensile force in the cable in the same way in which the output can also be operated by actuating the electric motor, in particular rotating about an axis of rotation, in order to press the brake lining against the friction lining. The brake can thus be actuated by the cable parallel to the electric motor in order to be able to actuate the brake, for example, if a power supply fails.

In particular, when the brake is used as a parking brake, it is advantageous if the brake is designed in such a way that a position of the brake is maintained if a power supply fails.

Furthermore, it can be provided that the brake is designed in such a way that the brake is actuated if a power supply fails, in particular, via a spring.

If the brake is provided as a driving brake, two brake circuits are generally provided. In such a case, it is usually desirable that the vehicle remains maneuverable even if one brake circuit fails. In that case, it is desirable that the brake is released if a power supply fails. To this end, it has proven to be advantageous that the brake is designed in such a way that the brake is released, in particular via a spring, if a power supply fails.

A brake designed according to the invention can, in principle, be designed in any desired manner, in particular as a drum brake or a disk brake. Furthermore, a brake according to the invention can also be designed as a floating caliper brake.

### BRIEF DESCRIPTION OF THE DRAWINGS

Further features, advantages and effects of the invention can be derived from the embodiments presented below. The drawings, to which reference is made, show the following:

FIG. 1 is a schematic representation of an electromechanical brake according to the invention;

FIG. 2 is a schematic representation of a method for producing a brake according to the invention;

FIG. 3 depicts different elasticity curves of a brake;

FIG. 4 is a detail representation of an embodiment of a brake according to the invention;

FIG. 5 is a schematic detail representation of a further embodiment of a brake according to the invention;

FIG. 6 is a detail representation of a brake according to the invention;

FIG. 7 is a schematic detail representation of a further embodiment of a brake according to the invention;

FIG. 8 is a schematic representation of a further embodiment of a brake according to the invention; and

FIG. 10 shows a ninth preferred embodiment of the vertical member in plan view.

### DETAILED DESCRIPTION

FIG. 1 shows a brake 1 according to the invention in a schematic representation. As can be seen, a transmission 3 is provided between an electric motor 2 and a brake lining 4, which, in a closing direction 6, can be pressed against a friction lining 5. The friction lining 5 can be formed, for example, by a brake disk of a motor vehicle, in particular a car, which is arranged to rotate with a wheel of the motor vehicle.

The brake lining 4 can be formed by brake shoes which are not connected to the motor vehicle in a rotating manner with a wheel of the motor vehicle. In order to achieve a small size, low weight and low cost, the invention provides that the transmission 3 has a variable transmission ratio over an actuation stroke which the brake lining 4 can execute between an open position of the brake 1 and a closed position of the brake 1. Usually the transmission ratio at the beginning of a stroke is greater than at an end of the actuation stroke since at the beginning of the actuation stroke an air gap 7 between the brake lining 4 and the friction lining 5 has to be overcome while at an end of the actuation stroke, the brake lining 4 rests on the friction lining 5 so that the electric motor 2 is subjected to a high counter-torque.

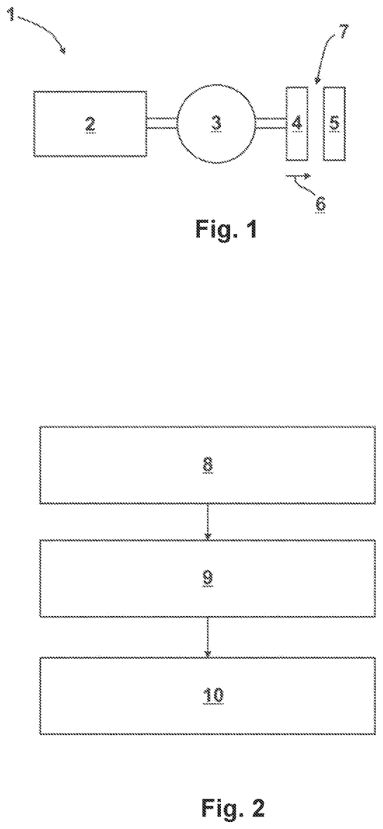

FIG. 2 shows a method according to the invention for producing a brake 1. In a first step 8, an electric motor 2, a brake lining 4, a friction lining 5 and a mechanical connection of these elements are selected, whereupon, in a second step 9, the brake lining 4, the friction lining 5, the mechanical connection, the electric motor 2 and, if necessary, other components acting against the counter-torque are determined. Then, in a third step 10, a transmission ratio of the transmission 3 is selected depending on the actuation stroke, such that the electric motor 2 is always operated at an optimal operating point over an actuation stroke when the electric motor 2 is actuated to operate the brake 1.

This is largely an operating point at which the electric motor 2 has maximum power so that the brake lining 4 is moved very quickly in the closing direction 6 over the air gap 7, with a transmission ratio usually being high, whereupon the brake lining 4 rests on the friction lining 5, whereupon the brake lining 4 is pressed further against the friction lining 5, with the transmission ratio usually being low.

In this regard, tolerances are usually taken into account within which the individual components of the brake 1 can exist so that an actuation is reliably possible even if the tolerances of the individual components of the brake 1 add up in the most unfavorable manner. In particular, manufacturing tolerances, friction losses in the transmission 3 and possible thermal expansions are calculated and taken into account. Furthermore, the transmission ratio is selected such that a reliable actuation is possible at an optimal operating point when the electric motor 2 is no longer able to generate a reduced motor torque due to a demagnetization at an end of a planned service life of the brake 1, due to increased temperature during operation, due to manufacturing tolerances and/or due to a reduction of a supply voltage only suitable for applying a reduced motor torque.

In addition, when designing the transmission ratio, which is not constant over the actuation stroke, it is taken into account that the elasticity of the friction lining 5 and the brake lining 4 can change due to the wear of the friction lining 5 and the brake lining 4 so that a reliable actuation is guaranteed even at a correspondingly increased rigidity.

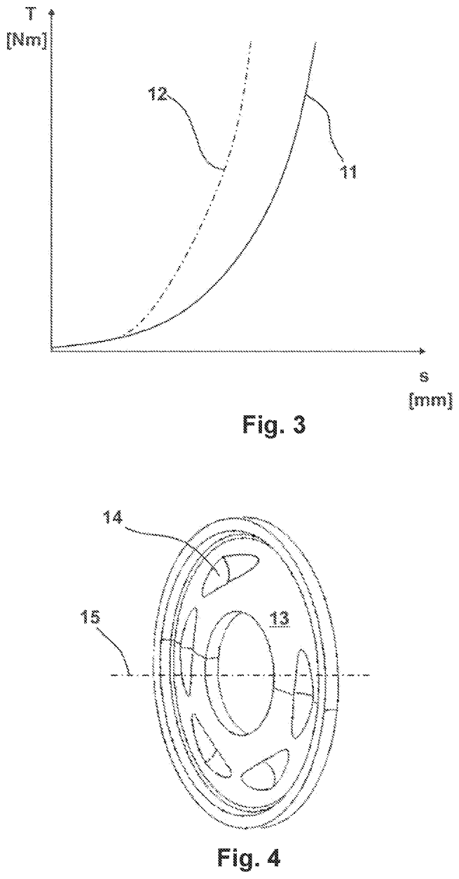

FIG. 3 shows a counter-torque over the actuation stroke of a brake 1 with a new friction lining 5 in a solid line 11 and, for comparison purposes, a dash-dotted line 12 shows a counter-torque of a brake 1 with a worn friction lining 5 and a worn brake lining 4. As can be seen, the brake 1, in which the friction lining 5 and brake lining 4 are worn after a certain stroke in which the brake lining 4 passes the air gap 7, has a stronger increasing counter-torque, which is taken into account when configuring the transmission ratio of the transmission 3 in such a way that the engine torque is always greater than the counter-torque acting on the electric motor 2 on account of the transmission 3. As a result, the brake 1 can be reliably actuated even with aging, and the electric motor 2 can be operated at an optimal operating point.

FIG. 4 shows part of a transmission 3 of a brake 1 according to the invention, which comprises a ball ramp 14 for the structural implementation of the transmission ratio which is not constant over the actuation stroke. Two disks 13 are provided in the transmission 3, at least one of which is formed with such ball ramps 14. By rotating a disk 13, the balls are caused to roll in the ball ramps 14 such that a minimum axial distance between the two disks 13 is defined by the ball ramps 14. As a result, the brake lining 4 connected to a disk 13 on the output side can be moved in the axial direction by rotating the electric motor 2 connected to a disk 13 on the output side. A transmission ratio of the transmission 3 thus formed by the ball ramps 14 depends on a gradient of the ball ramp 14 at a respective angular position and can be configured in a simple manner as desired by means of the actuation stroke. The disk 13 can be driven directly by means of the electric motor 2 or by means of a further transmission connected to the electric motor 2, which in turn can have a linear or a non-linear transmission ratio. Furthermore, a spring can, of course, also be provided in order to support the actuation of the brake 1 and/or the release of the brake 1.

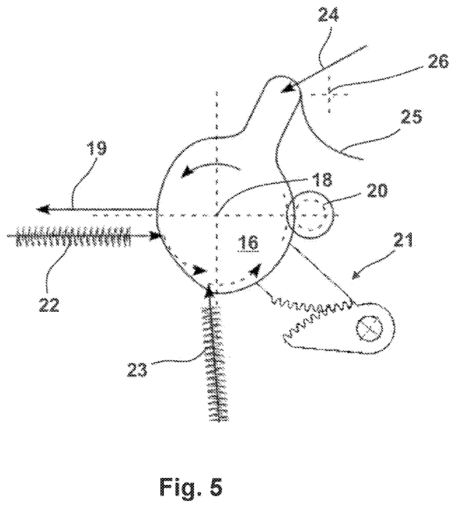

FIG. 5 shows a detail of a further embodiment of a transmission 3 of a brake 1 according to the invention in which the brake lining 4 is pressed against the friction lining 5 by means of a cam 16 or a cam disk. The cam 16 or cam disk has, on an outer contour, a variable distance from a cam axis 18 about which it is rotated by the electric motor 2. The cam 16 can be driven by the electric motor 2 by means of a gear pair 21, a pinion 20, a cam 25 rotatably mounted about a point of rotation 26, a connecting rod 24 or the like. In FIG. 5, the gear pair 21, the pinion 20, the cam 25 mounted about the point of rotation 26 and the connecting rod 24 are shown as examples of the connection between the electric motor 2 and the cam disk or the cam 16. The cam 16 can also be designed as a control disk mounted on a shaft, the center of which is located outside the shaft axis, or as a lever. The cam 16 can be actuated directly by means of the electric motor 2 or by means of a transmission connected to the electric motor 2, which in turn can have a linear or a non-linear transmission ratio.

On account of the contour of the cam 16 or the cam disk thus having a different distance from the cam axis 18, the brake lining 4 is moved or pressed in the direction of the friction lining 5 such that any transmission ratio adjustable by means of the actuation stroke can be achieved by means of the distance of the outer contour of the cam 16 or the cam disk of the cam axis 18, which is variable over a circumference of the cam 16 or the cam disk. As a result, a force applied by the electric motor 2 is translated into a pressing force 19 of different magnitudes on the basis of an actuation stroke of the brake 1. An actuating spring 22 and/or a reversing spring 23 can be provided in parallel to the electric motor 2 in order to assist with the actuation of the brake 1 and/or release of the brake 1.

Of course, other types of transmissions 3 known from the prior art can also be used as an alternative in order to achieve a transmission ratio which is not constant over the actuation stroke.

A brake 1 according to the invention can be designed not only as a disk brake but also as a drum brake. Furthermore, the brake lining 4 and the friction lining 5 can also be formed merely from components that move in a translatory manner, for example for linear displacement or up and down movements. Furthermore, the brake 1 according to the invention can be used in a motor vehicle both as a parking brake and as a driving brake.

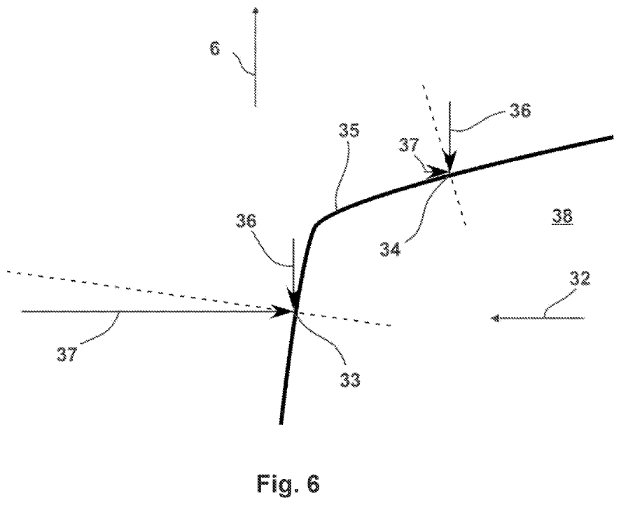

FIG. 6 shows a detail of a transmission 3 of a brake 1 according to the invention, which comprises a control element 38 with a contour 35 for the structural implementation of the transmission ratio that can be changed over the actuation stroke, which control element 38 can be moved along a drive direction 32 by means of the electric motor 2, not shown. The drive direction 32 can, of course, also be designed as a circular path, for example, about an axis of rotation 15 of the electric motor 2. The following considerations apply analogously for a rotatably mounted cam 16, a control disk by means of which the actuation takes place or the like.

A first contact position 33 and a second contact position 34 on the contour 35 are shown by way of example, at which contact positions 33, 34 an element connected to the brake pad 4 can slide in order to actuate the brake pad 4 by means of the electric motor 2 connected to the control element 38 in the closing direction 6. A local gradient of the contour 35 results in a transmission ratio from a movement of the contour 35 in the drive direction 32 to a movement of the brake lining 4 in the output direction or in the closing direction 6. The transmission ratio is consequently higher in the first contact position 33 than in the second contact position 34. In order to achieve a required closing force, however, a resulting supporting force 37 in the first contact position 33 perpendicular to the closing direction 6, which can lead to self-locking even at a low friction, is significantly higher than in the second contact position 34. In parallel to the closing force with which the brake lining is pressed against the friction lining, the closing reaction force 36 acts on the contour as shown. In order to prevent self-locking, the invention provides that, when determining the transmission ratio at the contour 35, the friction that occurs is taken into account in such a way that self-locking is avoided even in the event of friction that occurs in the worst case. This avoids a gradient of the contour 35, which is mathematically required to achieve a very high transmission ratio that is necessary, for example, for overcoming the air gap 7 but that would not be practically feasible due to the friction occurring on account of the self-locking.

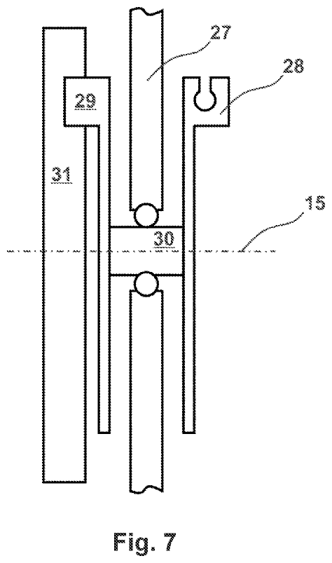

FIG. 7 schematically shows a brake 1 designed according to the invention, which can be actuated both by means of the electric motor 2 and the transmission 3 and by means of a cable attached to a cable connection 28. The transmission 3, not shown here, to which the electric motor 2 is connected, acts on an actuating part 31 to which the brake lining 4 is connected. A transmission element 30, which comprises the cable connection 28, is also connected to the actuating part 31 so that the actuation part 31 can be actuated both by means of the cable connection 28 and by means of the electric motor 2. As can be seen, the transmission element 30 is rotatably mounted about the axis of rotation 15 of the actuating part 31 in the housing 27 of the transmission 3. The actuating part 31 with the transmission element 30 is rotatably mounted by means of a driver 29. The driver 29 can be connected to the actuating part 31 in such a way that a movement of the driver 29 is transmitted to the actuating part 31, but a movement of the actuating part 31, which can be caused by the electric motor 2, does not cause a movement of the transmission element 30 or the cable connection 28. As a result, a corresponding brake 1 can easily be used both as a driving brake and as a parking brake in a motor vehicle. Due to the sealed mounting of the transmission element 30 in the transmission 3 and the cable connection 28 arranged outside the transmission 3, the cable can remain outside the transmission 3 so that sealing problems that would arise if a moving cable were to pass through the housing 27 of the transmission 3 are avoided.

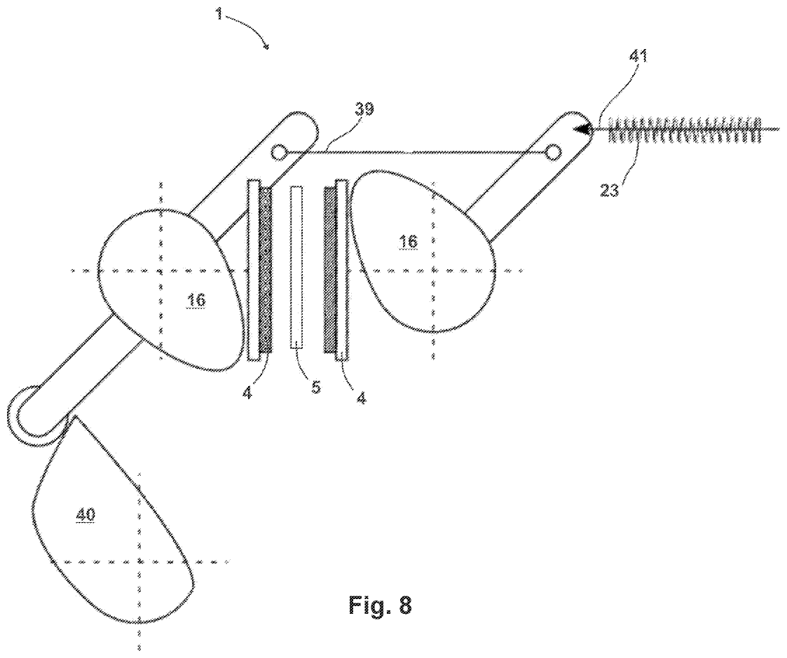

FIG. 8 shows a brake 1 according to the invention designed as a floating caliper brake. As can be seen, brake linings 4 are arranged on both sides of a friction lining 5, which is usually formed by a brake disk and which can be actuated by mechanically connected cams 16, which can be moved synchronously in opposite directions. The transmission ratio between an electric motor 2 (not shown) actuating the cams 16, which can be changed by means of the actuation stroke, and the movement of the brake linings 4 is realized here by means of the cams 16. Ball ramps 14 or other transmissions 3 could be used here as well. Furthermore, a spring 23 can also be provided here, as shown by way of example, in order to assist with the actuation or the opening of the brake 1. The electric motor 2 (not shown) can apply an actuating force 41 on the cams 16 by means of a lever, as shown, or also directly, of course. Alternatively, the electric motor 2 can also act on the cams 16 by means of an actuating cam 40, which is also shown for the purpose of illustration. As can be seen, the cams 16 are connected by means of a connecting element 39 such that the cams 16 move synchronously.

The brake 1 shown in FIG. 8 can be used for an elevator and arranged vertically in the elevator shaft, for example, by connecting the brake linings 4 to an elevator car and forming the friction lining with an element connected to the elevator shaft. The components of the brake 1 shown in FIG. 8 are thus generally arranged on the elevator car. The electric motor 2, not shown in FIG. 8, which acts on the cams 16, is generally arranged on the elevator car as well. When actuated, the brake 1 is centered by a horizontal movement of the elevator car such that both brake linings 4 rest equally on the friction lining 5 that is rigidly connected to the elevator shaft. Alternatively, the brake 1 shown in FIG. 7 can also be designed as a fixed caliper brake.

1-15. (canceled)

16. A method for determining design parameters of an electromechanical brake, the brake comprising an electric motor connected to a brake lining by a transmission, the brake lining adapted to press against a friction lining movable relative to the brake lining, the transmission having a transmission ratio which is not constant over an actuation stroke, comprising:
selecting an electric motor;
selecting a brake lining;
selecting a friction lining; and
selecting the transmission ratio based on a counter-torque acting over the actuation stroke, the counter-torque adapted to act on the transmission on account of the selected electric motor, the selected brake lining, the selected friction lining and a mechanical connection of these elements, the transmission ratio being selected so the electric motor is operated at an optimal operating point substantially over the entire actuation stroke.

17. The method according to claim 16, wherein the transmission ratio is selected so the electric motor is operated at a maximum power substantially over the entire actuation stroke.

18. The method according to claim 16, further comprising:
determining the counter-torque mathematically;
wherein the transmission ratio is a variable ratio.

19. The method according to claim 18, wherein the counter-torque is determined based on at least one of tolerances, an air gap between the brake lining and the friction lining when the brake is open, friction losses in the transmission, and possible thermal expansions.

20. The method according to claim 16, further comprising determining the counter-torque by a numerical simulation.

21. The method according to claim 16, wherein:
the transmission ratio is a variable ratio;
the transmission ratio being determined based on at least one of a reduction in a motor torque caused by a demagnetization at an end of a planned service life, an increased temperature, manufacturing tolerances, and a reduction in a supply voltage down to a lower limit at which a function of the brake still has to be guaranteed.

22. A method for producing an electromechanical brake, wherein the electromechanical brake is produced according to design parameters determined in a method according to claim 16.

23. An electromechanical brake, comprising:
an electric motor;
a brake lining; and
a friction lining arranged to be movable relative to the brake lining;
wherein the brake lining is adapted to press against the friction lining by means of the electric motor to convert mechanical energy into thermal energy by the friction between the brake lining and friction lining;
wherein the electric motor is connected to the brake lining by a transmission with an actuating stroke and a variable transmission ratio; and
wherein the electromechanical brake is produced by a method according to claim 22.

24. The electromechanical brake according to claim 23, wherein the variable transmission ratio is selected on a basis of the actuation stroke so the electric motor, when actuated, can be operated over the actuation stroke at an optimal operating point.

25. The electromechanical brake according to claim 24, wherein the variable transmission ratio is selected so the electric motor is operated at a maximum power substantially over the entire actuation stroke.

26. The electromechanical brake according to claim 23, wherein:
the transmission comprises two disks rotatable about an axis of rotation, the two disk being connected by at least one ball arranged in a ball ramp; and
the variable transmission ratio is at least partially formed by the ball ramp.

27. The electromechanical brake according to claim 23, wherein:
the transmission comprises at least one non-circular cam rotatably arranged about an axis of rotation; and
the variable transmission ratio is at least partially formed by the the non-circular cam.

28. The electromechanical brake according to claim 23, wherein the transmission comprises one of:
a control disk attached to a shaft, a center of the control disk being outside a shaft axis; and
a lever to implement the variable transmission ratio.

29. The electromechanical brake according to claim 23, wherein the transmission comprises at least one of:
a cam transmission;
a cam disk;
a connecting rod; and
a coupling mechanism.

30. The electromechanical brake according to claim 23, wherein the transmission is designed so that the variable transmission ratio has both positive and negative values over the actuation stroke.

31. The electromechanical brake according to claim 23, wherein the transmission is designed such that the variable transmission ratio is zero at least over a segment of the actuation stroke, a movement of the electric motor in the segment not causing a movement of the brake lining relative to the friction lining.

32. The electromechanical brake according to claim 23, wherein a cable connection is provided so that the brake lining can be pressed against the friction lining by pulling on a cable attached to the cable connection.

33. A vehicle with an electromechanical brake, wherein the electromechanical brake is designed according to claim 23.
